(19) United States
(12) Patent Application Publication
(10) Pub. No.: US 2012/0199204 A1
(43) Pub. Date: Aug. 9, 2012

(54) Household water reservoir

(76) Inventors: Edward Dobson, Alta Loma, CA (US); Viveka Nand, San Bernardino, CA (US)

(21) Appl. No.: 12/931,692

(22) Filed: Feb. 7, 2011

(51) Int. Cl. E03B 1/00; F03B 11/02

(52) U.S. Cl. 137/1; 137/613; 137/561 R

(57) ABSTRACT

A household water reservoir includes a reservoir body having a water inlet, a water outlet, and a water chamber communicating between the water inlet and the water outlet. The water inlet is operatively connected to a water inflow of the household water piping system. The water outlet is operatively connected to a water outflow of the household water piping system. Accordingly, the water chamber is adapted for reserving a predetermined amount of water when the water flows from the water inlet to the water outlet, in such a manner that the reservoir body enables the water being stored in the water chamber in fresh by keeping the water moving from the water inlet to the water outlet during daily water usage.

### BACKGROUND OF THE PRESENT INVENTION

1. Field of Invention

The present invention relates to an emergency survival kit, and more particular to a household water reservoir, which can reserve fresh water at any time for emergency use.

2. Description of Related Arts

Natural disaster, such as earthquake or flood, is a calamitous event that occurs suddenly and causes loss of life, damage, or hardship. When disaster strikes, a survival kit can keep a person safe. Generally speaking, a survival kit contains foods, supplies and tools, such as sleeping bag, flashlight, and knife, to provide a person with basic shelter and first aid needs.

In every public structure, the law regulates the owner to provide emergency lights, fire extinguishers, and even first aid kits but there is no emergency water supply while the most important element for human survival is water because human beings may survive without food for weeks but cannot survive without water just for couple days.

Although human beings store fresh water in reservoirs in countryside for daily use, it is too far from the populations for people to reach when disaster strikes. Government always encourage each household preparing own survival kit. For example, if there are five hundred thousand households in a city and each household should prepare ten gallons of stored water, the city may retain 5 million gallons of water in order to provide enough water for all households in the city. However, it is impossible to keep 5 million gallons of drinking water fresh and bacteria-free for human consumption. Therefore, government officials hope each household is ready to save enough fresh water when disaster happens. In other words, each household should keep the own drinking water fresh. However, from time to time, the households have to abandon the stored water and store another millions gallons of fresh water since the water stored in the container will stagnate and really go bad due to the sunlight and/or bacteria. It will be a great waste of water source.

Since water is an essential element for life, how to keep stored water fresh for long periods of time becomes a headache for person who prepares water in advance as an aid to survival in an emergency and an immediate topic to every government to balance the need of emergency usage of water and the prevention of waste of water source.

In addition, when disaster strikes, a person may be confined to his or her house or a public structure. In other words, even though fresh water is saved in a container, the person may unable to reach the water container. Also, when disaster strikes, people may have escape from their homes or public structures that they may not capable to reach the water container and carry the stored water with them.

### SUMMARY OF THE PRESENT INVENTION

The invention is advantageous in that it provides a household water reservoir which can reserve the fresh water at any time for emergency use.

Another advantage of the invention is to provide a household water reservoir which is adapted to be provided at human living area, such as house, office and public structure, and enables water keep flowing in and out with the daily usage of water to keep the stored water fresh for human consumption. It just like a reservoir shared into each user's living area as emergency water source that the total volume reserved has no change all the time but, in emergency, people can reach it handily for survival and/or carrying with them to escape when disasters happen.

Another advantage of the invention is to a household water reservoir, which would be installed into an existing water piping system without substantially altering the original structure thereof.

Another advantage of the invention is to a household water reservoir, which can reserve the fresh water in a reservoir body by keep flowing in-and-out the water during daily water usage. In other words, the reservoir body never stores water therein normally so as to keep the water fresh.

Another advantage of the invention is to a household water reservoir, wherein water in the reservoir body is ready to use or drink without any health concern.

Another advantage of the invention is to a household water reservoir which can be connected with other household water reservoirs to achieve the desired water volume to be stored.

Another advantage of the invention is to a household water reservoir which is installed to the water piping line of the house or structure in such a manner that it can close up its water inlet and outlet to keep the water therein as emergency water source when water supply is to the water piping line is stopped or when a person would like to carry the household water reservoir with him or her, wherein the size of the household water reservoir is made to store a predetermined volume of water to have a weight that people are able to move and carry.

Additional advantages and features of the invention will become apparent from the description which follows, and may be realized by means of the instrumentalities and combinations particular point out in the appended claims.

According to the present invention, the foregoing and other objects and advantages are attained by a household water reservoir which comprises a reservoir body having a water inlet, a water outlet, and a water chamber communicating between the water inlet and the water outlet. The water inlet is operatively connected to a water inflow of the household water piping system. The water outlet is operatively connected to a water outflow of the household water piping system. Accordingly, the water chamber is adapted for reserving a predetermined volume of water when the water flows from the water inlet to the water outlet, in such a manner that the reservoir body enables the water being stored in the water chamber in fresh by keeping the water flowing from the water inlet to the water outlet during daily water usage.

In accordance with another aspect of the invention, the present invention comprises a method of reserving water via a household water reservoir, comprising the steps of:

(a) coupling the household water reservoir to a household water piping system by operatively connecting a water inlet of a reservoir body to a water inflow of the household water piping system and operatively connecting a water outlet of the reservoir body to a water outflow of the household water piping system; and

(b) continuously reserving a predetermined volume of water within a water chamber of the reservoir body when the water runs from the water inlet to the water outlet, wherein the reservoir body enables the water being retained in the water chamber in fresh by keeping the water flowing from the water inlet to the water outlet during daily water usage.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a household water reservoir according to a preferred embodiment of the present invention, illustrating the household water reservoirs being stacked with each other.

FIG. 2 is a block diagram of the household water reservoir installing into a household water piping system according to the above preferred embodiment of the present invention.

FIG. 3 is a flow diagram illustrating a method of reserving fresh water by the household water reservoir according to the above preferred embodiment of the present invention.

FIG. 4 illustrates the household water reservoir being incorporated with the household water piping system according to the above preferred embodiment of the present invention.

FIG. 5 illustrates the household water reservoir formed as an emergency water source for public area according to the above preferred embodiment of the present invention.

### DETAILED DESCRIPTION OF THE PREFERRED EMBODIMENT

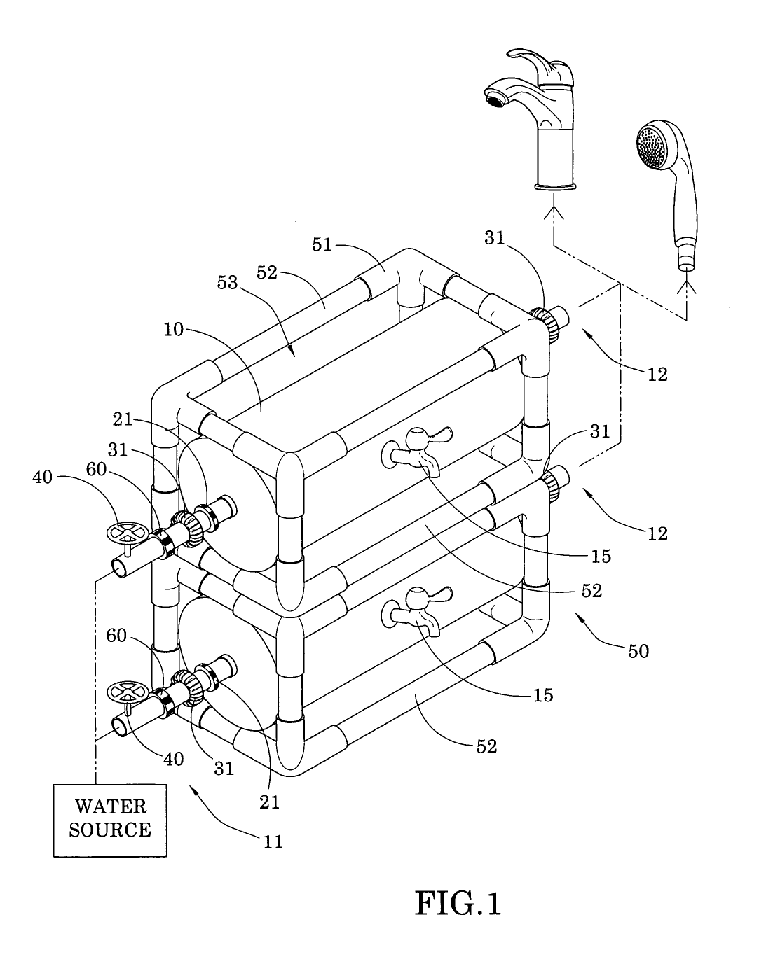

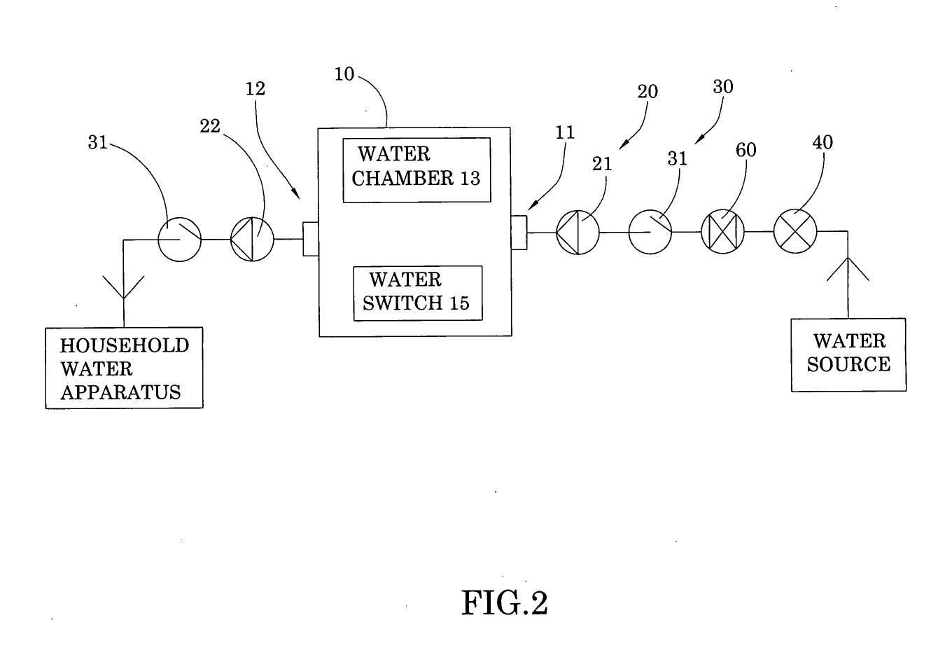

Referring to FIGS. 1 and 2 of the drawings, a household water reservoir according to a preferred embodiment of the present invention is illustrated, wherein one or more household water reservoirs are adapted for installing into a household water piping system in order to retain fresh water in the household water reservoir.

As shown in FIGS. 1 and 2, the household water reservoir comprises a reservoir body 10 which has a water inlet 11, a water outlet 12, and a water chamber 13 communicating between the water inlet 11 and the water outlet 12.

The water inlet 11 is operatively connected to a water inflow of the household water piping system, wherein the water inflow of the household water piping system is linked to a water source such that water runs from the water inflow to the water inlet 11.

The water outlet 12 is operatively connected to a water outflow of the household water piping system, wherein the water outflow of the household water piping system is linked to a household water apparatus, such as faucet, showerhead, or water fountain, such that water runs out of the water outlet 12 before running to the household water apparatus.

Accordingly, the water chamber 13 is adapted for reserving a predetermined volume of water, for example 5 gallons of water, when the water flows from the water inlet 11 to the water outlet 12, wherein water is temporary stored in the water chamber 13 before it is used. According to the water flow direction, the reservoir body 10 enables the water being stored in the water chamber 13 in fresh by keeping the water flowing from the water inlet 11 to the water outlet 12 during daily water usage. In other words, the operation of the household water apparatus will enable water flowing out of the water chamber 13 while water keeps running into the water chamber 13 as a refill from the water inlet 11. Therefore, the reservoir body 10 will only keep fresh, running water in the water chamber 13.

It is appreciated that the household water reservoir can be installed at any desired location of the household water piping system. For example, the reservoir body 10 can be installed into the kitchen water system at a position that the reservoir body 10 is located under the sink of the kitchen to operatively link to the kitchen faucet. The reservoir body 10 can also be installed into the bathroom to operatively link to either the showerhead or the bathroom faucet. It is appreciated that household water reservoir can be installed at two or more different locations of the household water piping system.

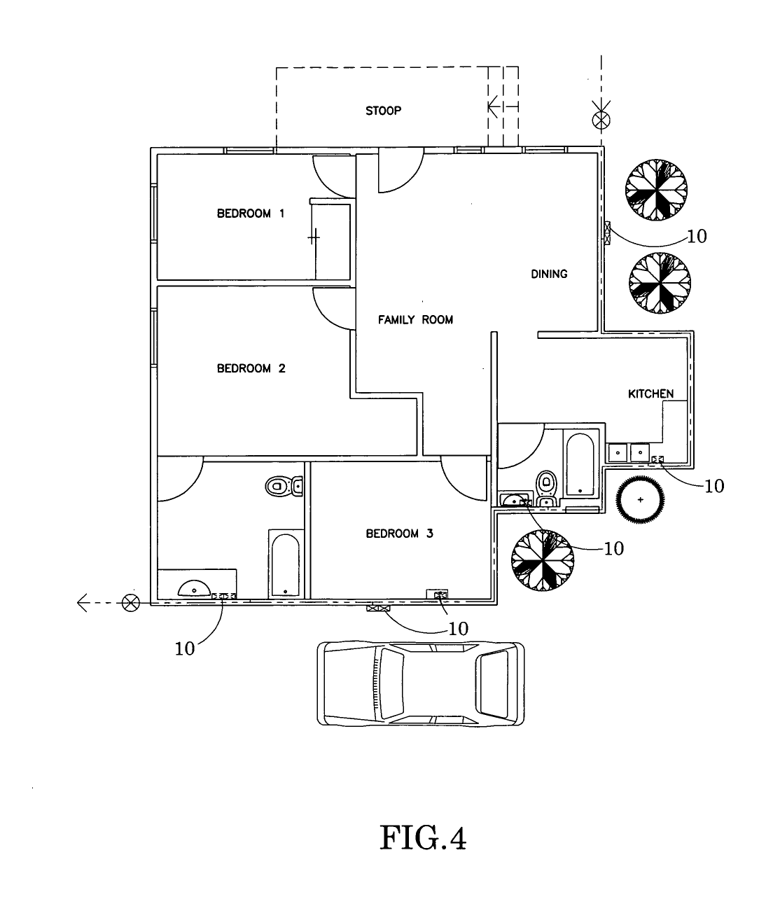

FIG. 4 illustrates a floor plan of the household water piping system incorporating with the household water reservoir of the present invention. Accordingly, one of more of the household water reservoirs can be selectively installed within the house, such as kitchen and bathroom, such that the user is able to save and use the fresh water at any time when he is confined to his house in an emergency. Preferably, the household water reservoirs are installed inside the cabinets along the water supply piping in kitchens or bathrooms so that the cabinets can also function as protection shelves thereof. The household water reservoirs can also be selectively installed outside the house, such as backyard or front yard, such that the user is able to take the fresh water without entering into the house when disaster strikes.

It is worth mentioning that the size of the household water reservoir is various that the reservoir body 10 can hold 1 to 5 gallons of water. Therefore, the user is able to install a plurality of household water reservoirs at different locations. For example, a family having four family members will need approximately 10 gallons of fresh water. Therefore, five household water reservoirs, each reserving two gallons of the water, will be installed. In addition, the household water reservoirs can be stacked together as shown in FIG. 1. Therefore, the household water reservoir does not requiring reserving 10 or more gallons of water by one reservoir body 10 which is impossible for the user to carry.

According to the preferred embodiment, the household water reservoir further comprises a flow control 20 for guiding water flow through the reservoir body 10 in one-direction manner. Accordingly, the flow control 20 comprises a first one-way flow control 21 operatively coupled at the water inlet 11 and a second one-way flow control 22 operatively coupled at the water outlet 12.

The first one-way flow control 21 is arranged for guiding water flowing from the water inlet 11 into the water chamber 13 in one-direction manner, so as to prevent the water back-flowing from the water chamber 13 to the water inlet 11.

The second one-way flow control 22 is operatively coupled at the water outlet for guiding the water flowing out of the water chamber 13 to the water outlet 13 in one-direction manner. In particular, the first and second one-way flow controls 21, 22 can prevent contaminated water from other sources to be drawn into the reservoir body 10.

According to the preferred embodiment, the first and second one-way flow controls 21, 22 are two water pressure valves respectively. When the water pressure at the water inflow of the water piping system is greater than the water pressure at the water chamber 13, the first one-way flow control 21 will be opened for allowing water flowing from the water inflow to the water chamber 13. When the water pressure at the water inflow of the water piping system is smaller than the water pressure at the water chamber 13, the first one-way flow control 21 will be automatically closed for blocking flowing back from the water chamber 13 to the water inflow.

It is worth mentioning that water will not be normally stored in the water chamber 13 because water keeps running from the water inlet 11 to the water outlet 12 through the water chamber 13. When water stops running, the predetermined volume of water will be reserved within the water chamber 13 at the time water is stopped flowing out the first one-way flow control 21.

The household water reservoir further comprises means 30 for detachably connecting the reservoir body 10 to the household water piping system, such that the reservoir body 10 can be detached from the household water piping system to form a portable water container in advance as an aid to survival in an emergency.

The detachably connecting means 30 comprises two quick-releasing joints 31 operatively coupled at the water inlet 11 and the water outlet 12 respectively for detachably coupling with the water inflow and the water outflow of the household water piping system, so as to enable the reservoir body 10 being detached from the household water piping system.

Accordingly, each of the quick-releasing joints 31 is a water pipe coupler adapted to seal and couple with the water pipe of the household water piping system and to unseal and detach from the water pipe thereof. Preferably, the attachment between each of the quick-releasing joints 31 and the water pipe can be obtained by a turn-and-slide movement so as to enable the reservoir body 10 being quickly detached from the household water piping system.

The household water reservoir further comprises a water valve 40 operatively coupled at the water inlet 11 for selectively shutting off the water inflow so as to stop the water flowing into the water chamber 13. Accordingly, the water valve 40 can be a shut off switch to shut off the water flow from the water inflow. In particular, the quick-releasing joint 31 at the water inlet 11 is positioned between the first one-way flow control 21 and the water valve 40 along the water flow direction. In other words, the water valve 40 is located in front of the quick-releasing joint 31 at the water inlet 11 of the reservoir body 10 along the water flow direction. Therefore, once the water valve 40 is manually actuated to shut off the water flow from the water inflow, the quick-releasing joint 31 at the water inlet 11 can be subsequently actuated to detach the reservoir body 10 from the household water piping system. It is worth mentioning that the first one-way flow control 21 will keep the fresh water in the water chamber 13 even though the reservoir body 10 is detached from the household water piping system. It is appreciated that the water valve 40 and the quick-releasing joint 31 at the water inlet 11 can be integrated to form a single switch control in such a manner that when the switch control is actuated, the water flow is automatically shut off and the reservoir body 10 is detached from the household water piping system at the same time.

As shown in FIG. 1, the reservoir body 10 further comprises a water switch 15 coupled thereat and communicated with the water chamber 13 for controllably discharging fresh water in the water chamber 13. Accordingly, the water switch 15 can be a switch to switch on for discharging water especially when the reservoir body 10 is detached from the household water piping system.

The household water reservoir further comprises a protection frame 50 for protecting the reservoir body 10. As shown in FIG. 1, the protection frame 50 comprises two side frames 51 positioned at two sides of the reservoir body 10 respectively and a plurality of reinforcing arms 52 spacedly extended between the side frames 51 to define a protection cavity 53 within the side frames 51 and the reinforcing arms 52 to encirclingly receive the reservoir body 10 in the protection cavity 53.

Each of the side frames 51 of the protection frame 50 is configured to form an encircling frame structure to encircle the respective side end of the reservoir body 10, wherein the reinforcing arms 52 are evenly extended between the side frames 51 to protect the main body of the reservoir body 10. Accordingly, for the household within the earthquake zone, the protection frame 50 is preferably is made of durable material, such as high strength and light weight alloy or plastic, for impact protection. For the household within the flood zone, the protection frame 50 is preferably is made of water floating material, such as foam material, to ensure said reservoir body being floated on water.

For healthy concern, the household water reservoir further comprises a water filter 60 operatively coupled at the water inlet 11 for filtering the water before the water enters into the water chamber 13. The water filter 60 is preferably coupled at a position after the water valve 40 along the water flow direction and is incorporated with the quick-releasing joint 31 at the water inlet 11 such that the water filter 60 is replaceable to ensure the quality of water being stored in the water chamber 13.

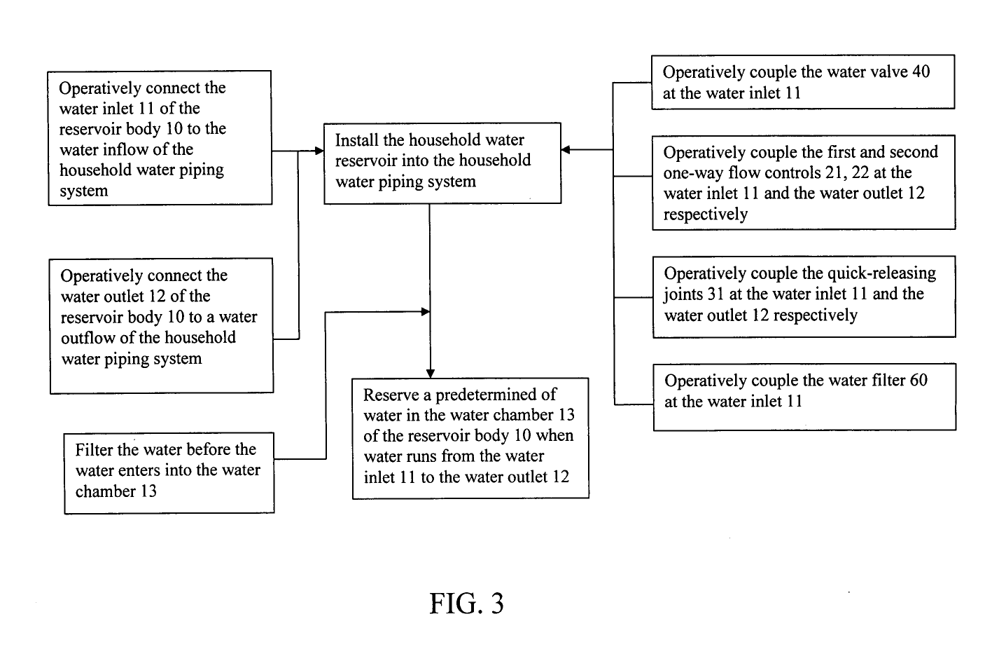

FIG. 3 further illustrates a method of reserving fresh water by the household water reservoir which comprises the following steps.

(1) Install the household water reservoir into the household water piping system.

(2) Keep reserving a predetermined of water in the water chamber 13 of the reservoir body 10 when water runs from the water inlet 11 to the water outlet 12.

According to the step (1), the installation of the household water reservoir comprises the following steps.

(1.1) Operatively couple the water valve 40 at the water inlet 11 in order to selectively shut off the water inflow for stopping the water flowing into the water chamber 13.

(1.2) Operatively couple the first one-way flow control 21 and second one-way flow control 22 at the water inlet 11 and the water outlet 12 respectively for ensuring water flowing at one single direction from the water inlet 11 to the water outlet 13 through the water chamber 13.

(1.3) Operatively couple the quick-releasing joints 31 at the water inlet 11 and the water outlet 12 respectively such that the reservoir body 10 can be detachably coupled between the water inflow and the water outflow of the household water piping system.

(1.4) Operatively couple the water filter 60 at the water inlet 11 in order to filter the water before the water enters into the water chamber 13. In other words, water reserved in the water chamber 13, in the step (2), is the filtered water and is ready to use and drink.

Once all the relative components are properly installed, the household water reservoir is ready to install into the household water piping system by operatively connecting the water inlet 11 of the reservoir body 10 to the water inflow of the household water piping system and operatively connecting the water outlet 12 of the reservoir body 10 to a water outflow of the household water piping system.

For emergency use, the user is able to shut off the water flow via the water valve 40 and detach the reservoir body 10 from the household water piping system via the quick-releasing joints 31. Therefore, the user is able to carry the reservoir body 10 while fresh water is prepared in advance as an aid to survival in an emergency. It is worth mentioning that the predetermined amount of fresh water is temporary stored in the water chamber 13 while the fresh water in the water chamber 13 is kept running during daily water usage. Therefore, water in the water chamber 13 will not stagnant therein and will not go bad due to the sunlight or bacteria.

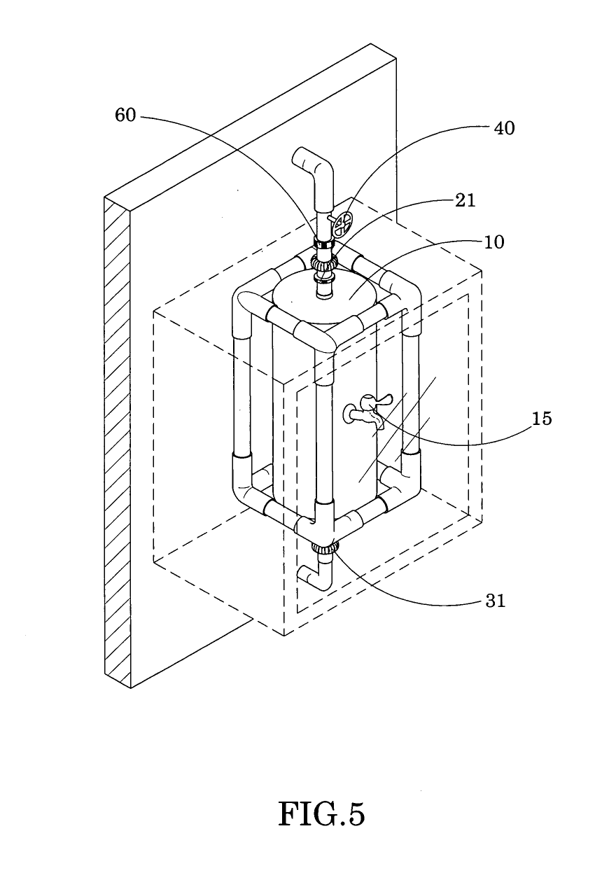

The household water reservoir can also be used in public area as shown in FIG. 5. Like the fire extinguisher box, one or more household water reservoirs can be placed in water reserving shelves at a location close to entrances and exits of the building such that the household water reservoirs can be used once the water reserving shelves are intentionally opened.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A household water reservoir for household water piping system, comprising:
a reservoir body having a water inlet adapted for operatively connecting to a water inflow of said household water piping system, a water outlet adapted for operatively connecting to a water outflow of said household water piping system, and a water chamber communicating between said water inlet and said water outlet, wherein said water chamber is adapted for reserving a predetermined amount of water when said water flows from said water inlet to said water outlet, in such a manner that said reservoir body enables said water being retained in said water chamber in fresh by keeping said water flowing from said water inlet to said water outlet during daily water usage.

2. The household water reservoir, as recited in claim 1, further comprising a first one-way flow control operatively coupled at said water inlet for guiding said water flowing into said water chamber in one-direction manner, and a second one-way flow control operatively coupled at said water outlet for guiding said water flowing out of said water chamber in one-direction manner.

3. The household water reservoir, as recited in claim 1, further comprising two quick-releasing joints operatively coupled at said water inlet and said water outlet respectively for detachably coupling with said water inflow and said water outflow of said household water piping system, so as to enable said reservoir body being detached from said household water piping system.

4. The household water reservoir, as recited in claim 2, further comprising two quick-releasing joints operatively coupled at said water inlet and said water outlet respectively for detachably coupling with said water inflow and said water outflow of said household water piping system, so as to enable said reservoir body being detached from said household water piping system.

5. The household water reservoir, as recited in claim 2, further comprising a water valve operatively coupled at said water inlet for selectively shutting off said water inflow so as to stop said water flowing into said water chamber.

6. The household water reservoir, as recited in claim 4, further comprising a water valve operatively coupled at said water inlet for selectively shutting off said water inflow so as to stop said water flowing into said water chamber.

7. The household water reservoir, as recited in claim 6, wherein said water valve is located in front of said quick-releasing joint at said water inlet of said reservoir body along a water flow direction.

8. The household water reservoir, as recited in claim 1, further comprising a protection frame for protecting said reservoir body, wherein said protection frame comprises two side frames positioned at two sides of said reservoir body respectively and a plurality of reinforcing arms spacedly extended between said side frames to define a protection cavity within said side frames and said reinforcing arms to encirclingly receive said reservoir body in said protection cavity.

9. The household water reservoir, as recited in claim 4, further comprising a protection frame for protecting said reservoir body, wherein said protection frame comprises two side frames positioned at two sides of said reservoir body respectively and a plurality of reinforcing arms spacedly extended between said side frames to define a protection cavity within said side frames and said reinforcing arms to encirclingly receive said reservoir body in said protection cavity.

10. The household water reservoir, as recited in claim 6, further comprising a protection frame for protecting said reservoir body, wherein said protection frame comprises two side frames positioned at two sides of said reservoir body respectively and a plurality of reinforcing arms spacedly extended between said side frames to define a protection cavity within said side frames and said reinforcing arms to encirclingly receive said reservoir body in said protection cavity.

11. The household water reservoir, as recited in claim 10, wherein said protection frame is made of durable material for impact protection.

12. The household water reservoir, as recited in claim 10, wherein said protection frame is made of water floating material to ensure said reservoir body being floated on water.

13. The household water reservoir, as recited in claim 4, further comprising a water filter operatively coupled at said water inlet for filtering said water before said water enters into said water chamber.

14. The household water reservoir, as recited in claim 10, further comprising a water filter operatively coupled at said water inlet for filtering said water before said water enters into said water chamber.

15. A method of reserving water via a household water reservoir, comprising the steps of:
(a) coupling said household water reservoir to a household water piping system by operatively connecting a water inlet of a reservoir body to a water inflow of said household water piping system and operatively connecting a water outlet of said reservoir body to a water outflow of said household water piping system; and
(b) reserving a predetermined volume of water in a water chamber of said reservoir body when said water runs from said water inlet to said water outlet, wherein said reservoir body enables said water being retained in said water chamber in fresh by keeping said water flowing from said water inlet to said water outlet during daily water usage.

16. The method, as recited in claim 15, wherein the step (a) further comprises the steps of:
(a.1) guiding said water flowing into said water chamber in one-direction manner by operatively coupling a first one-way flow control at said water inlet; and
(a.2) guiding said water flowing out of said water chamber in one-direction manner by operatively coupling a second one-way flow control at said water outlet.

17. The method, as recited in claim 16, further comprising a step of detaching said reservoir body from said household water piping system by operatively coupling two quick-releasing joints at said water inlet and said water outlet respectively for detachably coupling with said water inflow and said water outflow of said household water piping system.

18. The method, as recited in claim 17, further comprising a step of selectively shutting off said water inflow to stop said water flowing into said water chamber by operatively coupling a water valve at said water inlet.

19. The method, as recited in claim 18, wherein said water valve is located in front of said quick-releasing joint at said water inlet of said reservoir body along a water flow direction.

20. The method, as recited in claim 15, wherein the step (b) further comprises a step of filtering said water before said water enters into said water chamber.

21. The method, as recited in claim 18, wherein the step (b) further comprises a step of filtering said water before said water enters into said water chamber.

22. The method, as recited in claim 13, further comprising a step of protecting said reservoir body by a protection frame which comprises two side frames positioned at two sides of said reservoir body respectively and a plurality of reinforcing arms spacedly extended between said side frames to define a protection cavity within said side frames and said reinforcing arms to encirclingly receive said reservoir body in said protection cavity.

23. The method, as recited in claim 21, further comprising a step of protecting said reservoir body by a protection frame which comprises two side frames positioned at two sides of said reservoir body respectively and a plurality of reinforcing arms spacedly extended between said side frames to define a protection cavity within said side frames and said reinforcing arms to encirclingly receive said reservoir body in said protection cavity.

24. The method, as recited in claim 23, wherein said protection frame is made of durable material for impact protection.

25. The method, as recited in claim 23, wherein said protection frame is made of water floating material to ensure said reservoir body being floated on water.
